(19) United States
(12) Patent Application Publication
(10) Pub. No.: US 2019/0069526 A1
(43) Pub. Date: Mar. 7, 2019

(54) BEEHIVE FRAME STORAGE CONTAINER

(71) Applicants: Tracy A. Pielemeier, Westfield, IN (US); Karen M. Lancaster, Sheridan, IN (US)

(72) Inventors: Tracy A. Pielemeier, Westfield, IN (US); Karen M. Lancaster, Sheridan, IN (US)

(21) Appl. No.: 16/121,886

(22) Filed: Sep. 5, 2018

Related U.S. Application Data
(60) Provisional application No. 62/554,120, filed on Sep. 5, 2017.

(51) Int. Cl. A01K 47/02; A01K 47/06

(52) U.S. Cl. CPC A01K 47/02; A01K 47/06

(57) ABSTRACT

One form of the present application is directed to a beehive frame storage apparatus which includes an open top container having two opposing end wall panels, a horizontally extending frame support member located near an upper portion of each of the opposing end wall panels, and the frame support members are configured to permit a plurality of beehive frames to hang therefrom. The beehive frame storage apparatus further includes a plurality of vertically extending frame separation members protruding inwardly from each of the opposing end wall panels, and the plurality of frame separation members are configured to maintain a separation between the beehive frames. The beehive frame storage apparatus further includes a lid configured to engagingly cooperate with an upper edge of the open top container in a manner sufficient to form an enclosure.

### CROSS REFERENCE TO RELATED APPLICATIONS

The present application claims the benefit of U.S. Provisional Application No. 62/554,120, filed Sep. 5, 2017, the entire contents of which are expressly incorporated by reference.

### BACKGROUND

Modern beehives include a plurality of removable frames which hold various combs (e.g. honeycomb, brood comb, or the like) within the hive. These frames are removed for a variety of reasons, such as to inspect the hive and to extract honey from the hive. Once removed from the hive, these frames are often inadvertently exposed to dirt and debris (e.g. from the ground surrounding the hive). As one of skill in the art will appreciate, exposing the frames and combs to dirt and debris may not only add contaminates to any honey thereon, but can also lead to infestations of larvae, mold, or the like which can potentially kill a hive. To prevent the contamination of the combs, beekeepers will frequently stand frames upright in a storage tub. These frames are prone to fall over within the tub which can result in a loss of nectar, wax, honey, or the like retained on the comb. Moreover, when the frames fall the combs of multiple frames can stick together. Separating combs which have stuck together is a messy and tedious process and can result in destruction of the comb.

Although some storage tubs of the prior art are capable of supporting frames and housing frames, there are many drawbacks to these storage tubs. Storage tubs of the prior art often include a lid which is designed to tightly seal the tub. These tightly sealed prior art tubs are ideal for long term storage of clean, dry frames; however, they are not conducive for use in the bee-yard or for storage of damp comb material (e.g. from nectar, way, or honey). When the frames are removed from the hive, they are covered in bees. To utilize these prior art tubs to store frames with bees present, beekeepers leave the lids off the tubs. Although this open-top technique provides adequate ventilation, it prevents the containment of the bees and can result in the loss of the queen (e.g. should the queen decide to fly away or crawl out of the storage tub). The use of this partial enclosure also fails to provide any protection to the beekeeper from the bees.

These prior art tubs are also not suitable to transport bees. In order to catch and relocate a swarm, or to start a hive in a new location, it is necessary to transport bees in a vehicle (e.g. the bed of a truck). Although the tubs of the prior art are able to contain bees in a sealed configuration, they do not provide sufficient ventilation to transport bees over any distance. In such a sealed configuration, the bees can be subject to excessive heat as well as poor air quality-a toxic environment for bees.

Honey frames will often stick together in these prior art tubs and must be manually separated-a sticky, messy process which often results in tom combs and a loss of honey. Additionally, many users have a difficult time grasping these prior art tubs when wearing suitable gloves for beekeeping. Accordingly, there remains a need for further contributions in this area of technology.

### SUMMARY

One embodiment of the present invention is a unique beehive frame storage apparatus. Other embodiments include apparatuses, systems, methods, and combinations for the containment and storage of beehive frames. Further embodiments, forms, features, aspects, benefits, and advantages of the present application shall become apparent from the description and figures provided herewith.

### BRIEF DESCRIPTION OF THE DRAWINGS

The description herein makes reference to the accompanying drawings wherein like reference numerals refer to like parts throughout the several views, and wherein:

FIG. 1 is a schematic illustration of an embodiment of a beehive frame storage container;

FIG. 2 depicts a perspective view of a base structure of the present application;

FIG. 3 depicts a cut-away view of a lid of the present application;

FIGS. 4-5 depict a plan view of a lid of the present application;

FIGS. 6a and 6b depicts a cut-away side view of the beehive frame storage container in a stacked configuration;

FIG. 7 depicts a perspective view of an open top container according to a further form of the present application:

FIG. 8 depicts a plurality of beehive frames stored in the open top container of FIG. 7; and

FIG. 9 depicts a perspective view of a lid which cooperates with a rim of the open top container of FIG. 7 to form an enclosure.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

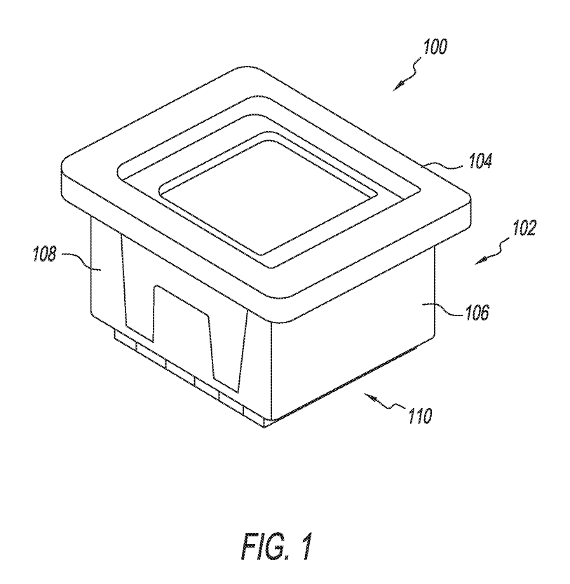

FIG. 1 depicts one embodiment of a beehive frame storage container 100. This beehive frame storage container 100 includes a base structure 102 and a lid 104. The base structure 102 is depicted as a substantially rectangular open top box which includes a base panel 110, end panels 106, and side panels 108.

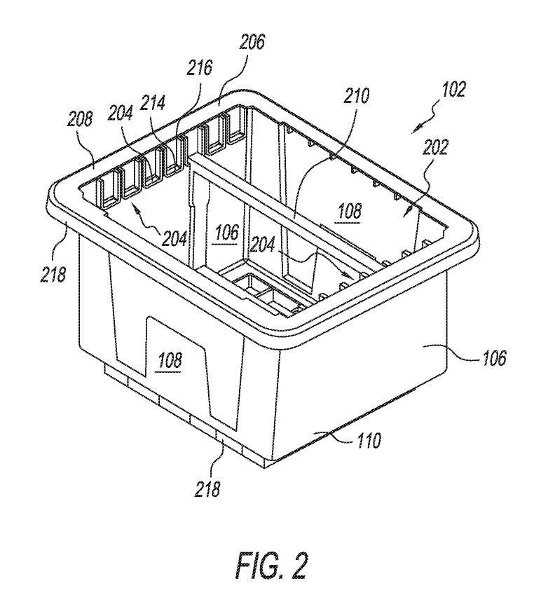

Referring now to FIG. 2, the base structure includes an interior cavity 202 in which beehive frames 210 can be stored. As will be readily understood to one of ordinary skill in the art, beehive frames 210 are designed to retain and support comb (not shown), such as honeycomb, brood comb, or the like within a beehive (not shown).

The beehive frame storage container 100 is designed to store a number of frames within the interior cavity 202 of the base structure 102. The frames 210 are supported by frame support channels 204 located in each of the opposing end panels 106. The frame 210 extends between the end panels 106 in a manner such that the frame cooperates with and is supported by the channels 204 on the opposing end panels 106. These frame support channels 204 support the frames 210 in a vertical orientation within the base structure 102 and prevent the frames 210 from falling on their side. Retaining the frames in a vertical orientation reduces the likelihood that the contents of the comb, or the comb itself, will fall out and/or damage to the comb will occur. Although the frame 210 is depicted as a Langstroth frame 210, it is contemplated that a variety of beehive frames can be vertically supported between the frame support channels 204.

The frame support channels 204 extend downwardly from an upper portion 206 of the opposing end panels 106. As is illustrated, the frame 210 extends between the opposing end panels 106 and is retained by cooperating frame support channels 204 located in the opposing end panels 106. In one specific form, the frame support channels 204 have a ledge 214 near a lower portion of the channel 204. In this form, hanging extensions 216, located on opposing ends of the frame 210, rest upon and are supported by the ledges 214 in a manner such that the frame 210 is suspended between the ledges 214.

The frame support channels 204 are depicted as being at least partially defined by opposing channel walls 216. These channel walls 216 provide separation between each of the frames 210 within the base structure 102 and prevent the frames 210 within the base structure 102 from touching. Separating the frames 210 prevents the comb from sticking together, and in turn prevents tearing when attempting to separate stuck frames 210. The hanging extension 216 of the frame 210 fits between the opposing channel walls 216 and is retained therein.

The base structure 102 is depicted as a substantially rectangular open top box having eight (8) opposing frame support channels 204. However, it is contemplated that a variety of configurations can be utilized to support any number of frames 210 depending upon the design parameters of a specific application. As will be discussed hereinafter, a stackable extension 218 extends downwardly from the base panel 110.

A rim 208 extends around an upper perimeter of the base structure 102. This rim 208 extends outwardly from an upper portion 206 of the end panels 106 and the side panels 108 and terminates at a downwardly extending lip 218. The rim 208 can serve as a carrying handle for the beehive frame storage container 100. Therefore, the rim 208 can be of a thickness sufficient for a beekeeper wearing bulky leather gloves to grasp the rim 208.

A complete enclosure is formed by cooperation between the lid 104 and the base portion 102. The rim 208 is designed to be received by and retained in the lid 104 such that this complete enclosure may be formed. When the lid 104 is placed on the base portion 102, the enclosure formed thereby is sufficiently tight to prevent any bees present on the frames 210 from escaping the enclosure.

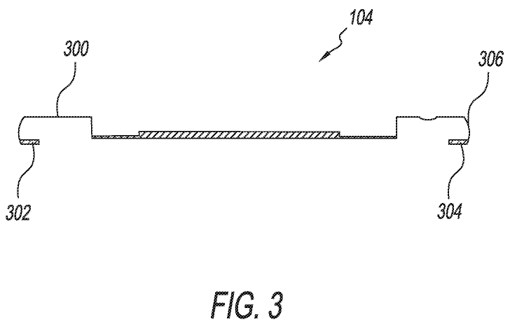

FIG. 3 depicts a cut-away view of the lid 104. The lid 104 receives the rim 208 of the base structure 102 in a manner such that a complete enclosure is formed thereby. The lid 104 includes a rim receiving area 302. When the lid 104 is placed on the base structure 102, the rim 208 of the base structure 102 extends upwardly into the rim receiving area 302. A tab 304, extending inwardly from an outer wall 306 of the rim receiving area 302, locks against the lip 218 of the rim 208 such that the lid 104 is mechanically retained to the base structure 102. This “snap type” of engagement between the lid 104 and the base structure 102 aids in the accidental opening of the enclosure.

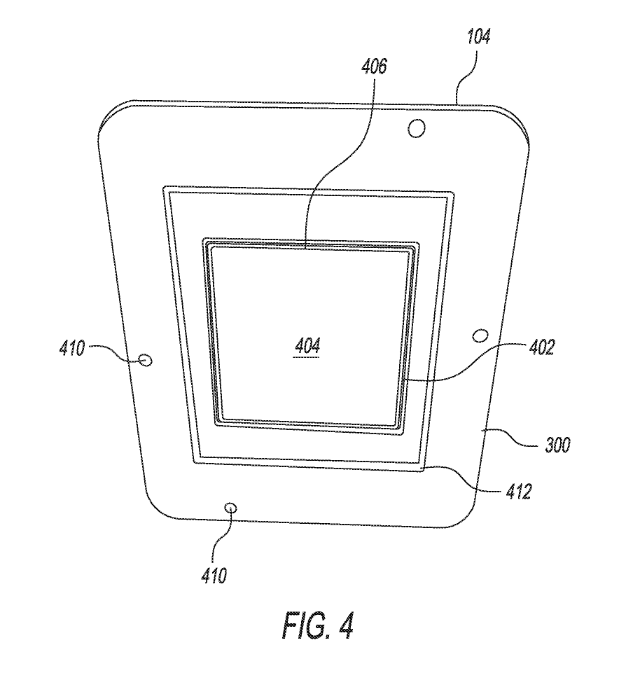

Although this “snap type” of engagement has been found to be strong, in some circumstances additional retainment strength between the lid 104 and the base structure 102 may be desired. Referring now to FIG. 4, a plurality of holes 410 can be located in an outer portion 300 of the lid 104. This outer portion 300 of the lid 104 rests atop the rim 208. Holes (not shown) can also be located in the rim 208 which will cooperate with and substantially align with the holes 410 in the lid 104. Upon attaching the lid 104 to rim 208 of the base structure 102, a user can then run zip ties, a rope, or the like through the holes 410 in the lid and the holes in the rim 208 to tightly secure the lid 104 to the base structure 102.

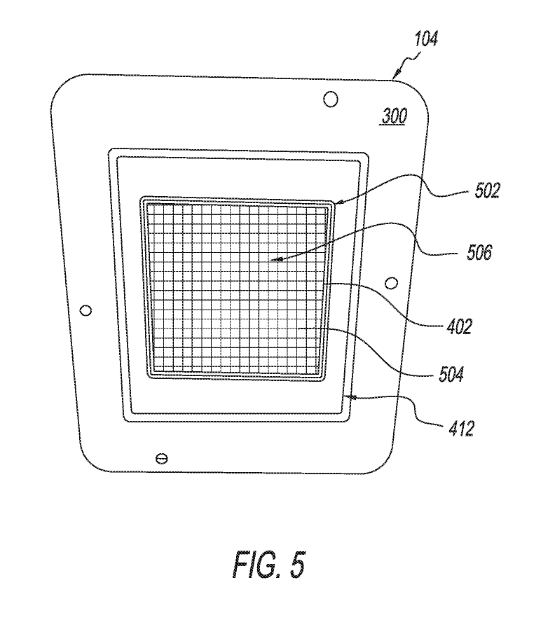

Referring to FIGS. 4-5, the lid 104 includes a selectively removable portion 404. A groove 402 surrounds an outer perimeter of this selectively removable portion 404. The material between the selectively removable portion 404 and the groove can be scored 406 such that the material is easier to cut and remove. Upon cutting the scored portion 406, the removable portion 404 can be taken from the lid 104 such that a hole 506 is formed in the lid 104. A mesh fabric 504 can then be suspended across the hole 506.

This mesh fabric 504 is retained to the lid 104 through the use of a seal 502. The seal 502 is configured to be received in the groove 402. The seal 502 is of a sufficient size such that the seal 502 will press against opposing walls of the groove 402 and be retained therein. This frictional fit between the seal 502 and the groove 402 retains the screen therebetween. To attach the mesh fabric 504 to the lid 104, a user will cover the hole 506 and the groove 402 with the mesh fabric 504. The user will then lay the seal 502 over the groove 402. Excess length of the seal 502 may be trimmed. The user can then depress the seal 502 into the groove 402 with the mesh fabric 504 wedged between the seal 502 and the groove 402.

In this manner, a lid 104 with the removable portion 404 attached thereto makes the beehive storage container 100 suitable for long term storage. Alternatively, a lid 104 with mesh fabric 504 provides proper ventilation for the storage and transportation of bees within the beehive storage container 100. Therefore, it is contemplated that multiple lids may be sold with the beehive storage container 100 or that a consumer has the option to pick a specific lid 104 type with their purchase.

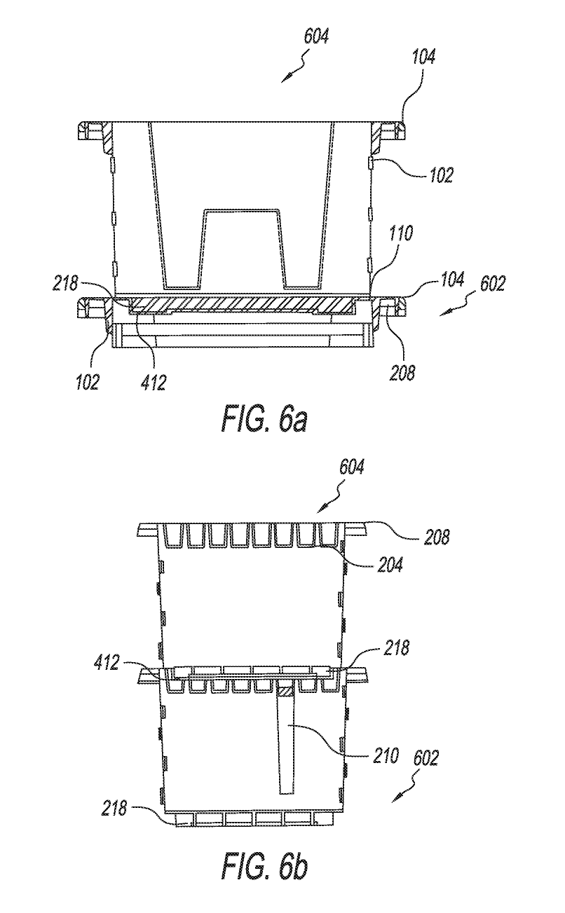

Multiple beehive frame storage containers 100 can be stacked atop one another. The lid 104 can include a stacking indentation 412. FIGS. 6a and 6b depict beehive frame storage containers 100 in a stacked orientation. The base structure 102 is depicted as having a stackable extension 218 extending downwardly from the base panel 110. When stacked, the stackable extension 218 of an upper container 604 is received in the stacking indentation 412 of a lower container 602. The cooperation of the stackable extension 218 in the stacking indentation 412 provides for a sturdy stacking configuration.

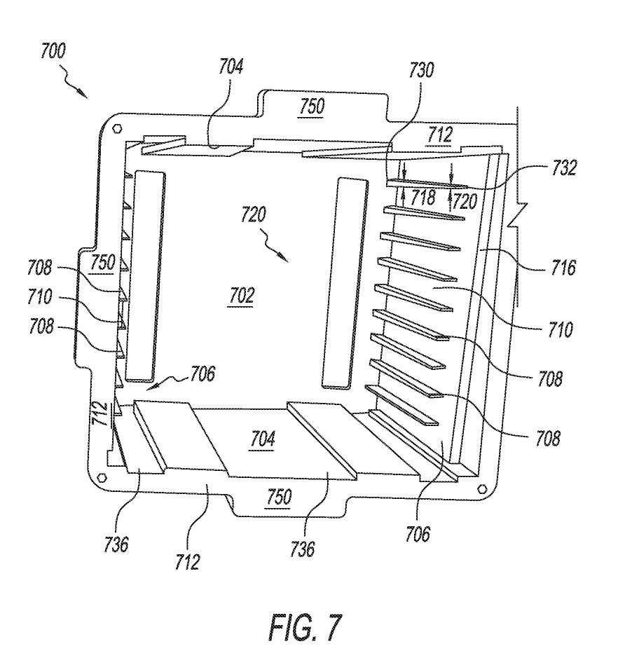

FIGS. 7-9 depict another form of a beehive storage container. A base structure 700 is depicted as a substantially rectangular open top container structure 700. This base structure 700 includes an interior cavity 720 in which beehive frames 210 can be stored. The base structure 700 can include frame separation members 708 and frame support members 716 to support and separate the beehive frames 210 stored therein. The beehive storage container further includes a lid 900 which cooperates with the base structure 700 to form a bee-proof enclosure.

Referring now to FIG. 7, the base structure 700 includes a base panel 702, end panels 706, and side panels 704. As is illustrated, the end panels 706 are located on opposite ends of the base structure 700, and therefore oppose one another.

Frame support members 716 are located on the end panels 706 of the base structure 700. Although these frame support members 716 take a different form than the support channels 204, the frame support members 716 perform a substantially similar function (e.g. the beehive frames 210 hang from the frame support members 716 such that the beehive frame 210 is suspended between the frame support members 716). The hanging extensions 216, located on opposing ends of the beehive frame 210, are supported by the frame support members 716 in a manner such that the frame 210 is suspended between the frame support members 716 and hangs down into the interior cavity 720 of the base 700. As illustrated, the frame support members 716 are substantially depicted as horizontally extending ledges which are integrally formed with the end panels 706; however, it is contemplated that the frame support members 716 can take a variety of forms to hangingly support the beehive frames 210 therebetween.

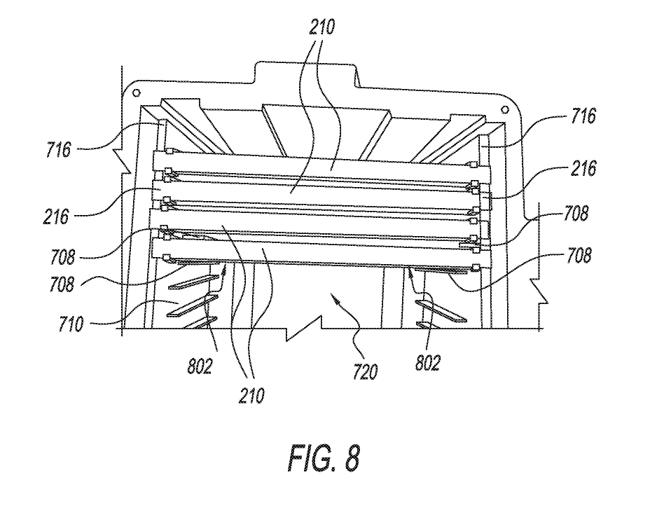

Frame separation members 708 help maintain the beehive frames 210 in a vertical orientation and prevent lateral movement (swaying) of the beehive frames 210. These frame separation members 708 additionally prevent contact between the frames 210, thereby preventing the combs from sticking together. The frame separation members 708 vertically extend along the end panels 706. In one form, each pair of the frame separation members 708 can define a frame receiving channel 710 therebetween. Opposing frame receiving channels 710 (located on opposing end panels 706) are configured to receive the sides 802, FIG. 8, of the beehive frame 210 therein. Cooperation between the frame separation members 708 and the beehive frames 210 helps to maintain the beehive frames 210 in a vertical orientation, even if the beehive storage container is subjected to harsh conditions (e.g. transport in the back of a pickup over unimproved roads).

The frame separation members 708 are depicted as extending vertically along the opposing end panels 706 from the base panel 702 to a location near the frame support members 716. However, it is contemplated that the frame separation members 708 can take a variety of forms to aid in the prevention of swaying (lateral movement) of the beehive frames 210 and to prevent contact between the beehive frames 210. For example, it is contemplated that the frame separation members 708 can extend upwardly from the base panel 702 and have no contact with end panels 706, frame separation members 708 may appear substantially as tabs extending outwardly from the end panels 706, frame separation members 708 may fully extend across the interior cavity 720 between the end panels 706, or the like.

In one form, a thickness 718 of the frame separation member 708 decreases between a base 730 of the frame separation member 708 and a terminus 732. It has been discovered that this taper (thinner at 720, thicker at 718) permits the beehive frames 210 to easily slide into the frame receiving channels 710 and also permits the beehive frame 210 to be “wedged” between the frame separation members 708 such that movement of the beehive frame 210 is substantially prevented.

An upper edge 736 of the end panels 706 and side panels 704 defines a rim 712. This rim 712 is similar to rim 208 in that it is designed to be received by and retained in the lid 900 such that a complete bee-proof enclosure may be formed. However, unlike rim 208, rim 712 is depicted as defining four carrying handles 750. These carrying handles 750 are located on each side panel 704 and each end panel 706 and are of a sufficient design to permit a beekeeper, wearing gloves to grasp the handle. As would be understood to a person of ordinary skill in the art, the inclusion of one handle 750 per side 704, 706, permits the user to grasp the container in a variety of positions and permits for ease of carry with two individuals.

FIG. 8 depicts the open container structure 700 supporting a plurality of beehive frames 210. As was previously discussed, the hanging extensions 216 of the beehive frames 210 rest on the frame support members 716. The frame separation members 708 cooperate with the sides 802 of the beehive frames 210 to prevent swaying of the beehive frames.

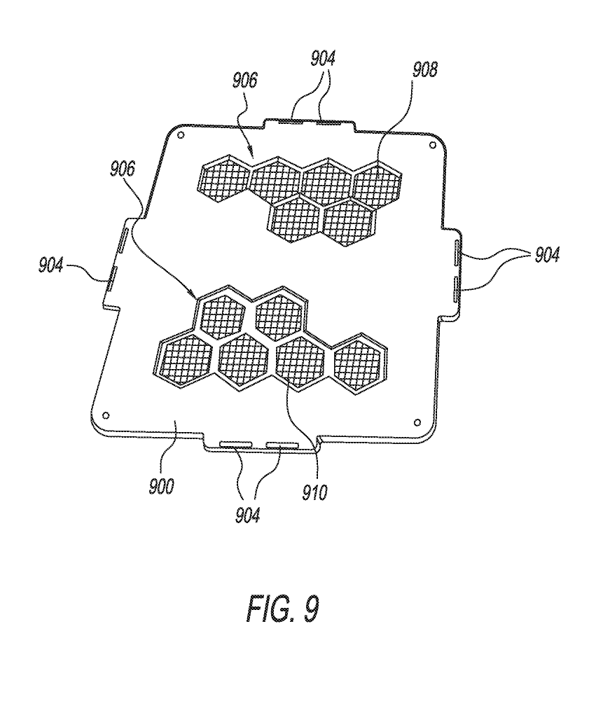

FIG. 9 depicts one form of a lid 900. This lid 900 is configured to mate with the rim 712, and is retained thereto via locking clasps 904. This lid 900 can mate to the base structure 700 in a similar manner as was previously described with regard to lid 104, however, in this form lid 900 includes four sets of locking clasps 904 (with one set of locking tabs per side) to provide a secure engagement of lid 900 to the base structure 700. In one specific form, the lid 900 includes two locking clasps (depicted as a set of locking clasps 904) which mate to each handle 750. In this specific form, the lid 900 includes a total of 8 locking clasps. As will be appreciated to a person of skill, this secure engagement between the lid 900 and the base structure 700 will greatly reduce the likelihood that bees will escape from the beehive frame storage container, even if the container is subject to adverse conditions (e.g. if the container is dropped).

In one form, the lid 900 is configured to permit airflow into the enclosure. The lid 900 is depicted as including mesh portions 908 and 910. In one form, the mesh portions 908 and 910 are integrally molded with the lid 900. As was previously described, the inclusion of the mesh portions 908, 910, and the airflow associated therewith, creates a suitable enclosure to contain bees therein. This airflow additionally reduces the likelihood of mold formation on the beehive frames 210 during storage.

In another form, the lid 900 is essentially solid (e.g. mesh portions 908, 910 are absent therefrom). In a further form, the beehive frame storage container can be sold as a kit where a user selects either a solid or ventilated lid and/or the container may include one of each lid type.

The lid 900 is further depicted with stacking indentations 906. As was described with regard to FIGS. 6a and 6b, these stacking indentations 906 cooperate with stackable extensions extending from the base structure 700 to permit stable stacking of multiple beehive frame storage containers. In one specific form, mesh portions 908, 910 are integrated into a lower portion of the stacking indentations 906; however, it is contemplated that the stackable indentations 906 can be integrated into the lid 900 in any manner suitable to receive and cooperate with the stackable extensions.

Although the base structure 700 has been heretofore described as being a substantially rectangular, the base structure 700 can take a variety of forms such that an open top container is formed with frame support members 716 extending substantially parallel therein. Moreover, although the terms “end panel” and “side panel” were used with specificity to aid in the previous description, these terms can be interchangeable and can encompass any wall-type panel of a container, as would be understood to a person of ordinary skill. Although the forms described in FIGS. 1-6 and FIGS. 7-9 have heretofore been described as separate, it is contemplated that a variety of forms and features can be crossed between the embodiments (e.g. frame separation members 708 can be placed in base portion 102, lid 104 can be utilized on base 700, etc.).

In a preferred form, the base structure 102 and/or 700 is produced via injection molding a high-density polyethylene. This manufacturing process yields a unitary, food grade base structure 102 and/or 700 which includes a smooth finish. A smooth finish permits any wax and/or honey which may have fell from the frames 210 to be easily removed from the base structure 102. In a preferred form, the lid 104 and/or 900 is additionally produced via injection molding of a high-density polyethylene. However, it is contemplated that the base structure 102/700 and the lid 104/900 can be constructed through a variety of forming and shaping techniques and be constructed of a variety of materials depending upon the specific design parameters of a given application.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Moreover, the term “at” is used broadly and encompasses locations which are in, on, or near.

What is claimed is:

1. A beehive frame storage apparatus, comprising:
an open top container including a base panel, opposing side panels, and opposing end panels;
a plurality of vertically extending frame separation members protruding inwardly from the opposing end panels, wherein the plurality of frame separation members define a plurality of vertically extending frame receiving channels therebetween;
wherein opposing frame receiving channels are configured to receive opposing sides of a beehive frame in a manner sufficient to provide lateral support to the beehive frame;
a rim defined by an upper edge of the opposing side panels and opposing end panels; and
a removable lid configured to engagingly receive and retain the rim in a manner sufficient to form a bee-proof enclosure.

2. The beehive frame storage apparatus of claim 1, further comprising a horizontally extending frame support member located at each of the opposing end panels, wherein the frame support members are configured to cooperate with hanging extensions of the beehive frame in a manner such that the beehive frame is hangingly suspended between the frame support members.

3. The beehive frame storage apparatus of claim 2, wherein the open top container, frame separation members, frame support members, and rim are integrally formed through injection molding.

4. The beehive frame storage apparatus of claim 2, wherein each of the plurality of frame separation members extend upwardly from a location at the base panel and terminate at a location vertically below the frame support members.

5. The beehive frame storage apparatus of claim 4, wherein a thickness of each of the plurality of frame separation members tapers inwardly from the location at the base panel to the location vertically below the frame support members.

6. The beehive frame storage apparatus of claim 1, wherein the rim further defines at least one carry handle at the upper edge of each side panel and each end panel.

7. The beehive frame storage apparatus of claim 1, wherein the lid further includes a mesh portion configured to permit airflow into an interior cavity of the enclosure.

8. The beehive frame storage apparatus of claim 7, wherein the base panel further includes a stackable extension and a top surface of the lid further includes a stacking indentation.

9. A beehive frame storage apparatus, comprising:
an open top container having two opposing end wall panels;
a horizontally extending frame support member located near an upper portion of each of the opposing end wall panels, wherein the frame support members are configured to suspend a plurality of beehive frames therefrom; and
a plurality of vertically extending frame separation members protruding inwardly from each of the opposing end wall panels, wherein the plurality of frame separation members are configured to maintain a separation between the beehive frames.

10. The beehive frame storage apparatus of claim 9, further comprising a lid configured to engagingly cooperate with an upper edge of the open top container in a manner sufficient to form an enclosure.

11. The beehive frame storage apparatus of claim 10, wherein the lid further comprises a mesh portion configured to permit airflow into an interior cavity of the enclosure.

12. The beehive frame storage apparatus of claim 10, wherein a top surface of the lid includes a groove surrounding a perimeter of a selectively removable portion, wherein a mesh is configured to be suspended across the selectively removable portion, wherein the mesh is retained between the groove and a frictional fit seal, and wherein the mesh is configured to permit airflow into an interior cavity of the enclosure.

13. The beehive frame storage apparatus of claim 9, wherein the open top container, the frame support members, and the vertically extending frame separation members are integrally molded of polyethylene in a manner sufficient to form a unitary structure.

14. The beehive frame storage apparatus of claim 9, wherein the plurality of frame separation members further define a plurality of vertically extending frame receiving channels therebetween, and wherein opposing frame receiving channels are configured to receive opposing sides of the beehive frames.

15. The beehive frame storage apparatus of claim 9, wherein the container further includes two opposing side panels, and wherein the upper edge further defines at least one carry handle at the upper edge of each side panel and each end panel.

16. A beehive frame storage container, comprising:
an open top container structure defined by a base panel, opposing side panels, a first end panel, and a second end panel opposite the first end panel;
a first frame support member extending along an upper portion of the first end panel;
a second frame support member extending along an upper portion of the second end panel, wherein the first frame support member and the second frame support member are substantially parallel, and wherein the first frame support member and the second frame support member are configured to suspend a plurality of beehive frames therefrom; and
a removable lid configured to cooperate with an upper edge of the end panels and the opposing side panels in a manner sufficient to form an enclosure, wherein the lid further includes a mesh portion configured to permit the flow of air into the enclosure.

17. The beehive frame storage container of claim 16, further comprising a plurality of vertically extending frame separation members protruding inwardly from the first end panel and the second end panel, wherein the plurality of frame separation members are configured to maintain the beehive frames in a substantially vertical orientation.

18. The beehive frame storage container of claim 17, wherein the frame separation members and the frame support members are integrally molded with the open top container structure.

19. The beehive frame storage container of claim 16, further comprising at least one carry handle in each of the side panels and the end panels near the upper edge.

20. The beehive frame storage container of claim 17, wherein the plurality of frame separation members define a plurality of vertically extending frame receiving channels, and wherein opposing frame receiving channels are configured to receive opposing sides of a beehive frame in a manner sufficient to provide lateral support to the beehive frame.
